(19) United States
(12) Patent Application Publication
(10) Pub. No.: US 2025/0362879 A1
(43) Pub. Date: Nov. 27, 2025

(54) METHOD AND APPARATUS FOR ADJUSTING PROBABILITY OF RANDOM BIT STREAM, AND COMPUTER STORAGE MEDIUM

(71) Applicant: PEKING UNIVERSITY, Beijing (CN)

(72) Inventors: Zongwei WANG, Beijing (CN); Yimao CAI, Beijing (CN); Houcheng LIU, Beijing (CN); Ru HUANG, Beijing (CN)

(73) Assignee: PEKING UNIVERSITY, Beijing (CN)

(21) Appl. No.: 18/995,415

(22) PCT Filed: Oct. 18, 2023
(86) PCT No.: PCT/CN2023/125138

§ 371 Date: Jan. 16, 2025

(30) Foreign Application Priority Data
Oct. 18, 2022 (CN) 202211271844.0

(51) Int. Cl. G06F 7/58; G06F 17/18

(52) U.S. Cl. CPC G06F 7/588; G06F 17/18

(57) ABSTRACT

A method for adjusting the probability a random bit stream includes: acquiring a random bit stream generated under an initial pulse condition when corresponding to the selection characteristic, and calculating a reference probability P_{base} of the random bit stream; evenly dividing a pulse sequence into N_{segment} segments, arbitrarily selecting Nₛₗₒₜ segments therefrom, and inserting a reset-set pulse signal pair into the selected Nₛₗₒₜ segments of the pulse sequence, wherein N_{segment}≥Nₛₗₒₜ≥1; after a reset pulse signal is received, setting the device to correspond to the resistance change characteristic, and setting a bit stream sequence generated by the Nₛₗₒₜ segments under the initial pulse condition to be “0”; after a set pulse signal is received, restarting generation of random bit stream according to the initial pulse condition; and calculating the probability of an adjusted random bit stream according to the reference probability P_{base} and adjusted random bit stream.

### CROSS REFERENCE TO RELATED DISCLOSURE

The present application claims priority to Chinese Patent Disclosure with No. 202211271844.0, entitled “Method and Apparatus for Adjusting Random Bit Stream Probability, and Computer Storage Medium”, and filed on Oct. 18, 2022, the content of which is expressly incorporated herein by reference in its entirety.

### TECHNICAL FIELD

The present disclosure relates to the field of novel type storage and computing technology, and particularly to a method and an apparatus for adjusting a random bit stream probability, and a computer storage medium.

### BACKGROUND

In recent years, although the number of components integrated per unit area of the CMOS integrated circuit chip is gradually increased, the development of Moore Law is gradually slowed down as the device size of the transistor approaches the physical limit. On the other hand, due to the influence of device process fluctuations, the circuit reliability decreases and the operating voltage cannot be reduced proportionally. Accordingly, due to the power consumption limitations, in an integrated circuit with multiple cores, only a small part of the cores can be in an actually effective working state in a certain period of time, which leads to the “dark silicon” dilemma. Faced with the above problem, it is possible to optimize the process, design a novel device to replace the transistors, or develop a novel type computational paradigms to innovate architectures and circuits in order to meet the requirements of novel technologies in multiple fields for low power consumption, reliability and circuit overhead. As a unary coding algorithm, stochastic computing is a revolutionary computing paradigm proposed from the perspective of data coding. The stochastic computing encodes the 0/1 in the traditional binary coding into bit streams with the equal weight, and the encoded value is determined by the proportion of “1” in the bit stream. Compared to the traditional binary computing, the stochastic computing has the advantage of high fault tolerance, simple circuit logic, low hardware overhead, and low power consumption. In the stochastic computing, since all bits have the same weight, a bit flip of any bit results in only a very small numerical error. Such fault tolerance can guarantee normal and effective operation of the stochastic computing circuit even under conditions of low operating voltage and high softe error rate. In addition, due to the unique encoding mode, the stochastic computing can use a simple gate circuit to implement complex logical calculations. For example, the multiplication calculations can be achieved through only one AND gate, thereby greatly reducing the hardware overhead and circuit power consumption.

The random bit stream generator is the most critical component in the stochastic computing circuit. However, the accuracy of the stochastic computing may be affected by the weak randomness and correlation of the random bit streams, resulting in a large error. Accordingly, additional randomization and decorrelation circuits need to be introduced into the traditional CMOS-based stochastic computing circuit, which weakens the advantage of low power consumption of the stochastic computing circuit. Random bit stream generators designed based on various novel devices, such as a resistive random access memory (RRAM), a threshold switch selection device, etc., have advantages of low power consumption and low hardware overhead.

However, the above mode of implementing the random bit stream generator can only adjust the probability of “1” in the generated random bit stream by adjusting the amplitude and pulse width of the applied voltage pulse. The adjustment range of the probability is limited and requires a very high precision. Meanwhile, the probabilistic switching of the device is difficult to be accurately predicted and controlled, which greatly increases the operation difficulty and circuit complexity, thereby further leading to an increase in energy consumption, area overhead and delay. Therefore, how to implement a probability-controllable random bit stream generator is a technical problem needing to be solved urgently and has very significant meaning.

### SUMMARY

As for the problem in the existing technology, the present disclosure provides a method and an apparatus for adjusting a random bit stream probability, and a computer-readable storage medium.

The technical solution of the present disclosure is provided as follows.

In the first aspect of the present disclosure, a method for adjusting a random bit stream probability is provided, which is applied to a device with resistive switching and selection characteristics, and the method includes:
acquiring a random bit stream generated by a device under an initial pulse condition when corresponding to the selection characteristic, and calculating a baseline probability P_{base} of the random bit stream;
dividing a pulse sequence of the random bit stream into N_{segment} segments on average, selecting Nₛₗₒₜ segments at random, and inserting one set of reset-set pulse signal pairs into the selected Nₛₗₒₜ segments, where N_{segment}≥Nₛₗₒₜ≥1;
setting the device to correspond to the resistive switching characteristic after receiving a reset pulse signal, and seeting a bit stream sequence generated by the Nₛₗₒₜ segments under the initial pulse condition to “0”;
restarting the generation of the random bit stream according to the initial pulse condition after receiving a set pulse signal; and
calculating an adjusted random bit stream probability according to the baseline probability P_{base} and an adjusted random bit stream.

In an embodiment, the calculating the baseline probability P_{base} of the random bit stream may include: determining a probability of “1” in the random bit stream as the baseline probability P_{base}.

In an embodiment, the calculating the adjusted random bit stream probability according to the baseline probability P_{base} and the adjusted random bit stream may include: calculating a probability of “1” in the random bit stream as Pₘ according to the following formula:

$${P}_{m} = {P}_{base} * ( {N}_{segment} - {N}_{slot} ) / {N}_{segment} .$$

In an embodiment, the device with resistive switching and selection characteristics has a two-terminal device structure or a three-terminal field effect transistor structure with a resistive switching layer and a phase change layer superimposed.

In an embodiment, the resistive switching layer is made of a metal oxide having the resistive switching characteristic.

In an embodiment, the phase change layer is made of a phase change material having an insulator-metal-transition characteristic.

In an embodiment, the metal oxide is HfO₂ or TaOₓ.

In an embodiment, the phase change material is VOₓ or NbOₓ.

In the second aspect of the present disclosure, an apparatus for adjusting a random bit stream probability is provided, including a processor and a memory storing a computer program executable on the processor, the processor, when executing the computer program, may implement the method of any of the above-mentioned method embodiments.

In the third aspect of the present disclosure, a computer-readable storage medium is provided, on which a computer program is stored, the computer program, when executed by a processor, may cause the processor to implement the method of any of the above-mentioned method embodiments.

In the present disclosure, the device integrating the resistive switching characteristic and selection characteristic is selected. The device integrating the resistive switching characteristic and selection characteristic has a dual-terminal device structure or a three-terminal field effect transistor structure having a resistive switching layer and a phase change layer that are superimposed. The device is in a high resistance state in the initial state, and at this moment, the device is in a non-volatile resistive switching mode and has a resistive switching characteristic. After a larger first forward voltage Vₛₑₜ is applied to the device, the device changes from the high resistance state to a low resistance state. In the low resistance state, after a second forward voltage Vbias less than Vₛₑₜ is applied to the device again, the device is turned on when the voltage is greater than the threshold voltage Vth, and at this moment, the device is in a volatile threshold switching mode and has a self-selection characteristic. Subsequently, a larger negative voltage Vᵣₑₛₑₜ is applied to the device, and the device is set back to the non-volatile resistive switching mode. At this moment, if a voltage greater than the threshold voltage Vth in the volatile threshold switching mode and less than the set voltage in the non-volatile resistive switching mode is applied to the device, the device fails to turn on. By using the switching characteristic between the resistive switching characteristic and the selection characteristic, the probability of “1” in the random bit stream can be controlled and linearly adjusted by controlling the pulse conditions. Due to the thermal disturbances, the current-voltage characteristic curve of the device in the threshold switching mode has certain fluctuations, and the corresponding operating voltages and turn-on delay time are also randomly distributed within a certain range. By using the turn-on delay time of the device as a random source, under a certain pulse condition, a random 0/1 sequence, i.e., a random bit stream, is generated. The probability of “1” in the random bit stream generated under a fixed pulse condition is determined as the baseline probability P_{base}. Due to the randomness and uniformity of the distribution of the the random bit streams, the probabilities of “1” in the random bit stream signals generated in different periods are approximately equal to Phase. After a reset pulse signal is randomly inserted into the pulse signal generated by the random bit stream, the device cannot turn on randomly under the original pulse signal and generates a “0” signal. To restart the generation of the random bit stream, a Vₛₑₜ signal greater than the original pulse signal needs to be applied to the device to set the device to the low impedance state such that the device is in the volatile threshold switching mode again. At this moment, the device can randomly turn on under the original pulse signal and regenerate 0/1 signals. By controlling the number of reset-set pulse signal pairs, the probability of the random bit stream can be adjusted in the range of 0 to P_{base}.

Compared to the conventional method for adjusting the probability, the present disclosure breaks through the restriction of relying on the pulse amplitude and the pulse width to adjust the probability of random bit stream. In the present disclosure, it is possible to implement the linear adjustment of the probability in a large range of 0 to P_{base} by controlling the number of the inserted reset-set pulse signal pairs under the fixed pulse condition.

The device with integrated resistive switching characteristic and selection characteristic used in the random bit stream generator of the present disclosure adopts a superimposed structure of a resistive switching layer and a phase change layer. The resistive switching layer can adopt a metal oxide with the resistive switching characteristic, such as HfO₂, TaOₓ, etc. The phase change layer can adopt a phase change material with an insulator-metal-transition (IMT) characteristic, such as VOₓ, NbOₓ, etc.

The technical effects of the present disclosure are provided as follows.
1. Compared to the existing random bit stream generator based on a novel device, in the present disclosure, the probability does not require adjustments of the pulse amplitude and pulse width, rather the probability of “1” in the finally generated random bit stream signal can be adjusted by randomly inserting a reset-set pulse signal pair under the fixed pulse condition, thereby reducing the complexity of the circuit.
2. In the present disclosure, the adjustment of the numerical precision can be implemented under a fixed bit stream length by adjusting the number of segments, which can further reduce the delay caused by the increase in bit stream length due to the increase in the precision in the conventional adjustment method.
3. In the present disclosure, since the adjustment of the probability is controlled by inserting “0”, the probability of “1” in the random bit stream can be predicted and controllably adjusted by setting the pulse conditions, while increasing the range and accuracy of the adjustment of the probability.

### BRIEF DESCRIPTION OF THE DRAWINGS

FIG. 1 shows a flow chart of a method for adjusting a random bit stream probability according to a specific embodiment of the present disclosure.

FIG. 2 is a schematic diagram of adjusting a random bit stream probability according to a specific embodiment of the present disclosure.

FIG. 3 is a schematic diagram showing obtaining of an adjustable probability based on a baseline probability by adjusting the number of inserted reset-set pulse signal pairs according to a specific embodiment of the present disclosure.

FIG. 4 is an internal structure diagram of an apparatus for adjusting a random bit stream probability according to a specific embodiment of the present disclosure.

### DETAILED DESCRIPTION

To facilitate understanding of the present disclosure, the present disclosure will be described more comprehensively below with reference to the relevant accompanying drawings. Embodiments of the present disclosure are shown in the accompanying drawings. However, the present disclosure may be implemented in many different forms and is not limited to the embodiments described herein. Rather, the purpose of providing these embodiments is to make the present disclosure more thorough and complete.

Unless defined otherwise, all technical and scientific terms used herein have the same meaning as commonly understood by those skilled in the art to which the present disclosure belongs. The terms used in the specification of the present disclosure are merely for the purpose of describing specific embodiments and are not intended to limit the present disclosure.

The present disclosure will be further clearly and completely described below through specific embodiments in conjunction with the accompanying drawings.

In the present disclosure, switching between the resistive switching characteristics and selection characteristics of a device is utilized to adjust the random bit stream probability. Initially, the device is set to a low-resistance state, corresponding to a volatile selection characteristic. After a large reset voltage is applied to the device, the device is set to a high-resistance state, and at this moment, the device is in a non-volatile resistive switching mode. Since the non-volatile resistive switching mode requires a large set voltage to put the device back to the low-resistance state, when a voltage greater than a threshold voltage in a threshold switching mode but less than the set voltage in the non-volatile resistive switching mode is applied to the device, the device cannot be turned on and a response current is very small. Subsequently, a large positive set voltage pulse signal is applied to the device, the device is turned on, and the current increases. Since the non-volatile device can be maintained in the low-resistance state, in the low-resistance state, a voltage pulse signal less than the set voltage but greater than the threshold voltage is applied to the device again, the device is turned on when the threshold voltage is reached, and the current increases. Due to the volatile characteristic, after the pulse signal is removed, the device still has the initial resistance value, which corresponds to the selection characteristic.

By utilizing the characteristic of switching between the non-volatile resistive switching mode and the volatile threshold switching mode of the device, the probability of “1” in the final random bit stream can be adjusted by controlling the pulse signal to insert “0” in the random bit stream.

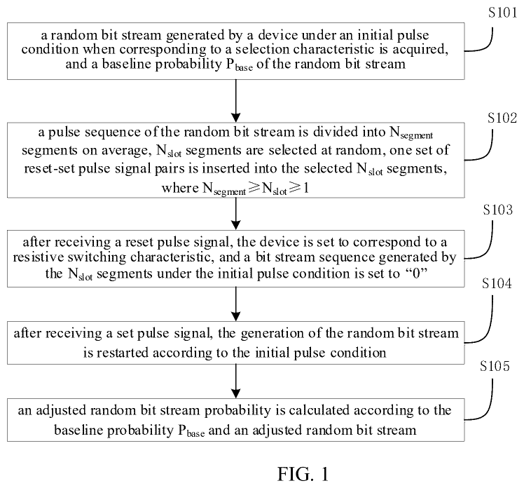

In an embodiment, referring to FIG. 1, it shows a flow chart of a method for adjusting a random bit stream probability. In this embodiment, the method is applied to a terminal as an example for illustration. It should be appreciated that the method can also be applied to a system including a terminal and a server, and implemented through the interaction between the terminal and the server. As shown in FIG. 1, the method for adjusting the random bit stream probability may include the following steps.

S101: a random bit stream generated by a device under an initial pulse condition when corresponding to a selection characteristic is acquired, and a baseline probability P_{base} of the random bit stream.

Specifically, for calculating the baseline probability P_{base} of the random bit stream, the probability of “1” in the random bit stream may be determined as the baseline probability P_{base}.

S102: a pulse sequence of the random bit stream is divided into N_{segment} segments on average, Nₛₗₒₜ segments are selected randomly from the N_{segment} segments, one set of reset-set pulse signal pairs is inserted into the selected Nₛₗₒₜ segments, where

$${N}_{segment} ⩾ {N}_{slot} ⩾ 1.$$

S103: after receiving a reset pulse signal, the device is set to correspond to a resistive switching characteristic, and a bit stream sequence generated by the Nₛₗₒₜ segments under the initial pulse condition is set to “0”.

S104: after receiving a set pulse signal, the generation of the random bit stream is restarted according to the initial pulse condition.

S105: an adjusted random bit stream probability is calculated according to the baseline probability P_{base} and an adjusted random bit stream.

Specifically, the step of calculating the adjusted random bit stream probability according to the baseline probability P_{base} and the adjusted random bit stream includes that the probability of “1” in the random bit stream is calculated as Pₘ according to the following formula:

$${P}_{m} = {P}_{base} * ( {N}_{segment} - {N}_{slot} ) / {N}_{segment} .$$

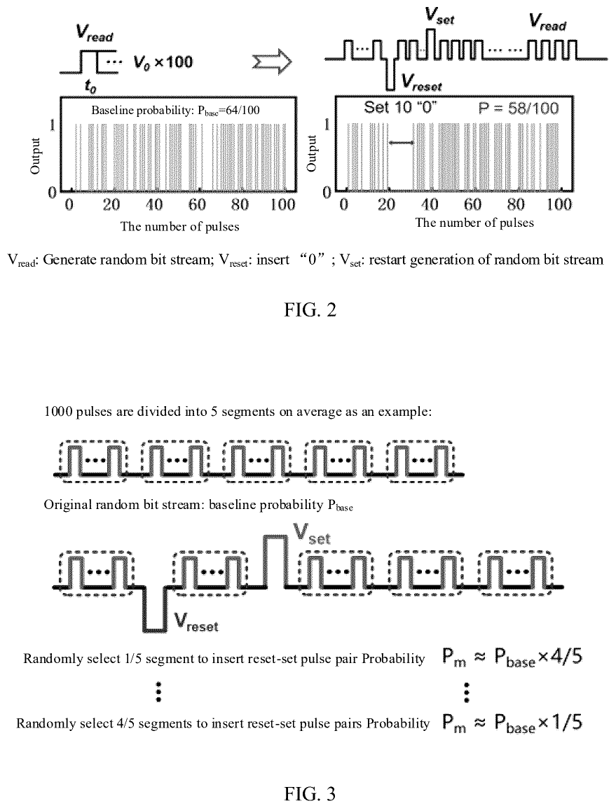

In an embodiment of the present disclosure, as shown in FIG. 2, due to thermal disturbance, the device in the volatile threshold switching mode has different corresponding output currents under the same pulse condition. An output current can correspond to a 0/1 bit in the random bit stream according to a magnitude of the output current. Assuming that the probability of “1” in the random bit stream outputted by the device under a certain pulse condition (V₀, t₀) is the baseline probability P_{base} and taking a specific baseline probability P_{base}=64/100 as an example, one set of reset-set pulse signal pairs is inserted into the original pulses. Since the device cannot be turned on at the original voltage after reset, the correspondly generated bit is “0”. For example, by inserting the reset voltage Vᵣₑₛₑₜ signal after the 20th pulse signal, the 21th to 30th bit outputs of the original random bit stream can be set to “0”. After the set voltage Vₛₑₜ signal is applied, the device can restart the generation of the random bit stream. By continuing to apply the original pulse signal after the Vset signal, the device can regenerate a random bit stream. After the adjustment, a random bit stream sequence with a probability of 58/100, for example, can be finally obtained.

The key to adjusting the random bit stream probability in the present disclosure is to: insert the reset-set pulse signal pair, divide the original pulse sequence for generating a random bit stream with a baseline probability of P_{base} into N_{segment} segments on average, select Nₛₗₒₜ segments from the N_{segment} segments at random, and insert one set of reset-set pulse signal pairs into the selected segments, so that the random bits generated by the Nₛₗₒₜ segments can be set to “0”. Therefore, after the reset-set pulse signal pair is inserted, the probability of “1” in the finally obtained random sequence is equal to Pₘ=P_{base}*(N_{segment}−Nₛₗₒₜ)/N_{segment}, where N_{segment}≥Nₛₗₒₜ≥1.

In another embodiment of the present disclosure, as shown in FIG. 3, a schematic diagram of specific applied pulse conditions and calculation formulas for the final obtained probabilities are given, with the number of original pulse signal sequences being 1000 and the number of segments being 5 as an example. Specifically, in the example where the number of original pulse signal sequences is 1000 and the number of segments is 5 as an example, each segment corresponds to 200 pulse signals. Accordingly, if one segment is randomly selected and one set of reset-set pulse signal pairs is inserted, the correspondly obtained probability Pₘ is approximately equal to P_{base}×⅘. If two segments are selected randomly and one set of reset-set pulse signal pairs is inserted, the correspondingly obtained probability Pₘ is approximately equal to P_{base}×⅗, and so on, until the number of the selected segments satisfies Nₛₗₒₜ=4 (when Nₛₗₒₜ=5, Pₘ is equal to 0). By increasing the number of reset-set pulse signal pairs, the probability of the random bit stream can be gradually adjusted from the baseline probability to the minimum.

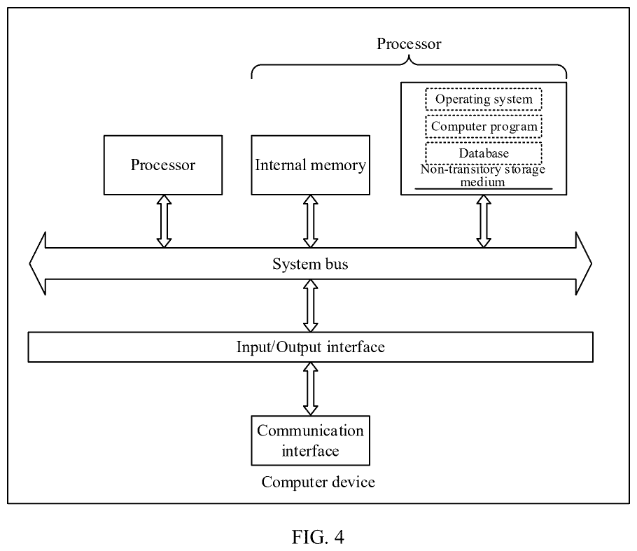

In an embodiment, an apparatus for adjusting a random bit stream probability is provided. The apparatus may be a computer device, the computer device may be a server, and an internal structure diagram thereof may be as shown in FIG. 4. The computer device includes a processor, a memory, an input/output (I/O) interface and a communication interface. The processor, the memory and the input/output interface are connected to each other via a system bus, and the communication interface is connected to the system bus via the input/output interface. The processor of the computer device is configured to provide computing and control capabilities. The memory of the computer device includes a non-transitory storage medium and an internal memory. The non-transitory storage medium stores an operating system, a computer program, and a database. The internal memory provides an environment for the operations of the operating system and computer program in the non-transitory storage medium. The database of the computer device is configured to store data information. The input/output interface of the computer device is configured to exchange information between the processor and an external device. The communication interface of the computer device is configured to communicate with an external terminal via a network connection. The computer program, when executed by the processor, causes the processor to implement a method for adjusting a random bit stream probability.

Those skilled in the art may understand that the structure shown in FIG. 4 is merely a block diagram of a partial structure related to the solution of the present disclosure, and does not constitute a limitation on the computer device to which the solution of the present disclosure is applied. The specific computer device may include more or fewer components than shown in the figure, or combine certain components, or have a different arrangement of components.

In an embodiment of the present disclosure, an apparatus for adjusting a random bit stream probability is provided, including a processor and a memory storing a computer program executable on the processor, the processor, when executing the computer program, may implement the following steps of:
acquiring a random bit stream generated by a device under an initial pulse condition when corresponding to a selection characteristic, and calculating a baseline probability P_{base} of the random bit stream;
dividing a pulse sequence of the random bit stream into N_{segment} segments on average, selecting Nₛₗₒₜ segments randomly from the N_{segment} segments, and inserting one set of reset-set pulse signal pairs into the selected Nₛₗₒₜ segments, where N_{segment}≥Nₛₗₒₜ≥1;
setting the device to correspond to a resistive switching characteristic after receiving a reset pulse signal, and seeting a bit stream sequence generated by the Nₛₗₒₜ segments under the initial pulse condition to “0”;
restarting the generation of the random bit stream according to the initial pulse condition after receiving a set pulse signal; and
calculating an adjusted random bit stream probability according to the baseline probability P_{base} and an adjusted random bit stream.

In an embodiment of the present disclosure, the processor, when executing the computer program, may further implement the following step of:

calculating the probability of “1” in the random bit stream as Pₘ according to the following formula:

$${P}_{m} = {P}_{base} * ( {N}_{segment} - {N}_{slot} ) / {N}_{segment} .$$

In another embodiment of the present disclosure, a computer-readable storage medium is provided, on which a computer program is stored, the computer program, when executed by a processor, may cause the processor to implement the following steps of:
acquiring a random bit stream generated by a device under an initial pulse condition when corresponding to a selection characteristic, and calculating a baseline probability P_{base} of the random bit stream;
dividing a pulse sequence of the random bit stream into N_{segment} segments on average, selecting Nₛₗₒₜ segments randomly from the N_{segment} segments, and inserting one set of reset-set pulse signal pairs into the selected Nₛₗₒₜ segments, where N_{segment}≥Nₛₗₒₜ≥1;
setting the device to correspond to a resistive switching characteristic after receiving a reset pulse signal, and seeting a bit stream sequence generated by the Nₛₗₒₜ segments under the initial pulse condition to “0”;
restarting the generation of the random bit stream according to the initial pulse condition after receiving a set pulse signal; and
calculating an adjusted random bit stream probability according to the baseline probability P_{base} and an adjusted random bit stream.

A person of ordinary skill in the art can understand that all or part of the processes in the above-mentioned method embodiments can be implemented by instructing related hardware through a computer program. The computer program can be stored in a non-transitory computer-readable storage medium. The computer program, when executed by a processor, may cause the processor to implement the processes of the above-mentioned method embodiments. Any reference to a memory, a database, or other medium used in the embodiments provided in the present disclosure may include at least one of a non-transitory memory and a transitory memory. The non-transitory memory may include a read-only memory (ROM), a magnetic tape, a floppy disk, a flash memory, an optical storage, a high-density embedded non-transitory memory, a resistive random access memory (ReRAM), a magnetoresistive random access memory (MRAM), a ferroelectric random access memory (FRAM), a phase change memory (PCM), a graphene memory, etc. The transitory memory may include a random access memory (RAM) or an external cache memory, etc. By way of illustration and not limitation, the RAM may be in various forms, such as a static random access memory (SRAM) or a dynamic random access memory (DRAM). The database involved in each embodiment provided in the present disclosure may include at least one of a relational database and a non-relational database. The non-relational databases may include, but is not limited to, distributed databases based on blockchain, etc. The processor involved in each embodiment provided in the present disclosure may be a general-purpose processor, a central processing unit, a graphics processor, a digital signal processor, a programmable logic unit, a data processing logic unit based on quantum computing, etc., but is not limited thereto.

The technical limitations in the above embodiments may be combined in any way. To make the description concise, all possible combinations of the technical limitations in the above embodiments are not described. However, as long as there is no contradiction in the combinations of these technical limitations, these combinations should be considered to be within the scope of the present disclosure.

The above-described embodiments only express several implementation modes of the present disclosure, and the description is relatively specific and detailed, but should not be construed as limiting the scope of the patent disclosure. It should be noted that, those of ordinary skill in the art can make several modifications and improvements without departing from the concept of the present disclosure, and these all fall within the protection scope of the present disclosure. Therefore, the protection scope of the present disclosure should be subject to the appended claims.

The invention claimed is:

1. A method for adjusting a random bit stream probability, applied to a device with integrated resistive switching characteristic and selection characteristic, the method comprising:
acquiring a random bit stream generated by a device under an initial pulse condition when corresponding to the selection characteristic, and calculating a baseline probability P_{base} of the random bit stream;
dividing a pulse sequence of the random bit stream into N_{segment} segments on average, selecting Nₛₗₒₜ segments randomly from the N_{segment} segments, and inserting one set of reset-set pulse signal pairs into the selected Nₛₗₒₜ segments, where N_{segment}≥Nₛₗₒₜ≥1;
setting the device to correspond to the resistive switching characteristic after receiving a reset pulse signal of a reset-set pulse signal pair, and setting a bit stream sequence generated by the Nₛₗₒₜ segments under the initial pulse condition to “0”;
restarting generation of the random bit stream according to the initial pulse condition after receiving a set pulse signal of the reset-set pulse signal pair; and
calculating an adjusted random bit stream probability according to the baseline probability P_{base} and an adjusted random bit stream obtained after restarting the generation of the random bit stream.

2. The method for adjusting the random bit stream probability according to claim 1, wherein the calculating the baseline probability P_{base} of the random bit stream comprises:
determining a probability of “1” in the random bit stream as the baseline probability P_{base}.

3. The method for adjusting the random bit stream probability according to claim 1, wherein the calculating the adjusted random bit stream probability according to the baseline probability P_{base} and the adjusted random bit stream comprises:
calculating a probability of “1” in the random bit stream as Pₘ according to the following formula:
$${P}_{m} = {P}_{base} * ( {N}_{segment} - {N}_{slot} ) / {N}_{segment} .$$

4. The method for adjusting the random bit stream probability according to claim 1, wherein the device with integrated resistive switching characteristic and selection characteristic has a two-terminal device structure or a three-terminal field effect transistor structure with a resistive switching layer and a phase change layer superimposed.

5. The method for adjusting the random bit stream probability according to claim 4, wherein the resistive switching layer is made of a metal oxide having the resistive switching characteristic.

6. The method for adjusting the random bit stream probability according to claim 4, wherein the phase change layer is made of a phase change material having an insulator-metal-transition characteristic.

7. The method for adjusting the random bit stream probability according to claim 5, wherein the metal oxide is HfO₂ or TaOₓ.

8. The method for adjusting the random bit stream probability according to claim 6, the phase change material is VOₓ or NbOₓ.

9. An apparatus for adjusting a random bit stream probability, comprising a processor and a memory storing a computer program executable by the processor, wherein the processor, when executing the computer program, implements the method of claim 1.

10. A computer-readable storage medium, on which a computer program is stored, wherein the computer program, when executed by a processor, causes the processor to implement the method claim 1.
